(19) United States
(12) Patent Application Publication
(10) Pub. No.: US 2019/0185119 A1
(43) Pub. Date: Jun. 20, 2019

(54) Holding Means for Holding an Apparatus Against a Metallic Surface

(71) Applicant: BRI NorHull AS, Sandnes (NO)

(72) Inventor: Morten Urrang, Stavanger (NO)

(73) Assignee: BRI NorHull AS, Sandnes (NO)

(21) Appl. No.: 16/328,067

(22) PCT Filed: Aug. 24, 2017
(86) PCT No.: PCT/NO2017/050211

§ 371 Date: Feb. 25, 2019

(30) Foreign Application Priority Data
Aug. 26, 2016 (NO) 20161367

(51) Int. Cl. B63B 59/10; B63B 59/08; B62D 55/18; B62D 55/065

(52) U.S. Cl. CPC B63B 59/10; B63B 59/08; B60B 2900/931; B62D 55/0655; B62D 55/18

(57) ABSTRACT

A solution is provided for the problem of holding an apparatus against a metallic hull of a vessel or an offshore unit. Described is a holding means, comprising: at least one magnetic means for exerting a pushing force on the apparatus to-wards the metallic surface; and a moving means for moving the apparatus on the metallic surface, in which the moving means is arranged to bear the pushing force from the at least one magnetic means, on the metallic surface. Also disclosed, is an apparatus including such a holding means. The holding means allows to bear the pushing force from the magnetic means, on the metallic surface, at the same time it allows the apparatus to move on it.

### TECHNICAL FIELD

The present application relates to a holding means for holding an apparatus against a metallic surface.

### BACKGROUND

A steel hull of a vessel or of other installation requires operations to be made on it, namely an inspection, a maintenance or a repair operation. Such an operation can be cleaning it with a water jet, with a moving brush, with an ultrahigh water jet, cavitation or with any other cleaning means; performing construction work such as installing a sea chest plug or welding; performing at least one measurement in a certain location of the hull, for example for the purposes of executing a detailed survey; or capturing a video feed from a location on the hull.

Certain difficulties can be observed when performing such an operation. For example, one difficulty may be when the hull is immersed partially, which creates difficulties when reaching the part of the hull above the surface. Another difficulty may be, for example, related to the specific shape of the hull, which may vary substantially from structure to structure. A further difficulty may be, for example, related to the dimensions of a metallic hull, which are usually observed in structures with big dimensions, when compared to the size of the components used for performing the operation.

A known approach for performing an operation on a steel hull, involves the use of a Remote Operated Vehicle (ROV). The ROV is manoeuvred to the vicinity of the intended position on the hull, carrying the necessary components with it for performing the operation. It can be deployed either from a support vessel or from the structure of which the hull is part. This approach is well-known in the prior-art and is considered a proven technology. However, it has critical drawbacks that make impractical.

One of the drawbacks is that any surfaced portion of the hull cannot be reached by the ROV. Hence, an additional solution has to be used for performing the operation on the surfaced parts of the hull.

Another drawback, is that the ROV does not move in an effective manner when near the upper part of the submerged portion of the hull, known as the splash zone. This zone has challenging hydrodynamic conditions for the driving means of the ROV to tackle, in order keep the ROV in place in relation to the hull. One of the problems in this zone is that the ROV is neutral in water due to its buoyancy element, and therefore needs to be fully submerged in order to operate. Heave and water current bring the ROV, involuntarily, to surface. This can be partially overcome by waiting for the appropriate weather conditions to be achieved. However, if the solution depends on weather conditions, which can be quite strict, it might take a long time to achieve them. For example, in practice it was observed during an intervention to a hull in the North Sea, which required a weather limit of 2.0 m Hs, that it took ten days before the intended limit could be achieved. A scenario in which a structure such as a vessel has to wait for several days before certain weather conditions are achieved can become quite expensive, since during that period the vessel may have to endure through parking costs without generating any income from the usual commercial exercise of the vessel.

Another known approach is to send divers into the water to the perform a similar operation to the ROV. This approach is also well-known. Although, in certain circumstances, a diver might be quicker or more precise than a ROV, many of the drawbacks of the ROV are still observed in this approach. Any surfaced portion of the hull cannot be reached by the diver. Also, a diver must be careful and take into account the hydrodynamic conditions when moving in the splash-zone. Further, this approach significantly depends on the skills and experience of the diver. Moreover, some hulls when in operation, need to have thrusters running, which make this approach impossible due to high risk.

### GENERAL DESCRIPTION

Described is a holding means for holding an apparatus against a metallic surface, comprising: at least one magnetic means for exerting a pushing force on the apparatus towards the metallic surface; and a moving means for moving the apparatus on the metallic surface, wherein the moving means is arranged to bear the pushing force from the at least one magnetic means, on the metallic surface.

In one embodiment, the moving means comprises a continuous track system for moving the apparatus on the metallic surface. The continuous track system comprises: a continuous track; and at least two conducting means for conducting the continuous track.

In another embodiment, the continuous track of the continuous track system is arranged around the at least one magnetic means, for keeping the at least one magnetic means separated from the metallic surface.

In a further embodiment, the continuous track is adapted with at least one inner guide for keeping the continuous track aligned with the movement of the apparatus on the metallic surface, and wherein at least two conducting means is adapted with a groove for the at least one inner guide to engage thereon.

In one embodiment the continuous track is a track belt.

In another embodiment, the at least one magnetic means is arranged in a Halbach array for augmenting a magnetic field of the magnetic means facing the metallic surface.

In a further embodiment, the metallic surface is a metallic hull. In one embodiment, the metallic hull is a part of a vessel. In another embodiment, the metallic hull is a part of an offshore unit.

Also, disclosed is an apparatus for performing an operation on a metallic surface, comprising at least one holding means.

In one embodiment, the apparatus comprises at least one pivoting means for pivoting the at least one holding means in relation to the apparatus, wherein the at least one pivoting means is arranged for adapting the at least one holding means to a shape of the metallic surface.

In another embodiment, the at least pivoting means is arranged to pivot in a transverse axis of the apparatus. In a further embodiment, the at least one pivoting means is arranged to pivot in a longitudinal axis of the apparatus.

### BRIEF DESCRIPTION OF THE DRAWINGS

So that the invention may be more readily understood, and so that further features thereof may be appreciated, embodiments of the invention will now be described by way of example with reference to the accompanying drawings.

FIG. 1 is a schematic illustration showing an orthogonal projection of a first embodiment of the holding means against a metallic surface.

FIG. 2 is a schematic illustration showing a side view of the first embodiment in the longitudinal direction of the same.

FIG. 3 is a schematic illustration showing an orthogonal projection of a second embodiment of the holding means against a metallic surface, wherein the five permanent magnets are arranged in a Halbach array, as is shown by the arrows therein shown.

FIG. 4 is a schematic illustration showing a side view of the second embodiment in the transverse direction of the same.

FIG. 5 is a schematic illustration showing a side view of a third embodiment of the holding means against a metallic surface, in the transverse direction of the same, wherein a track belt is shown with inner guides.

FIG. 6 is a schematic illustration showing another side view of the third embodiment shown in FIG. 5, in the longitudinal direction of the same.

FIG. 7 is a schematic illustration showing an orthogonal projection of a fourth embodiment of the holding means against a metallic surface, wherein a track belt is shown being conducted around several instances of the holding means and also being driven by a central drum.

FIG. 8 shows a schematic illustration showing a side view of the fourth embodiment in the longitudinal direction of the same.

FIG. 9 shows a schematic illustration showing a side view of a fifth embodiment of the holding means against a metallic surface, in the longitudinal direction, while this embodiment moves over a protrusion in the metallic surface.

FIG. 10 shows a schematic illustration similar to FIG. 9, with some components hidden.

FIG. 11 shows a schematic illustration showing an orthogonal projection of an embodiment of an apparatus including a frame and four instances of the fourth embodiment shown in FIGS. 7 and 8.

FIG. 12 shows a schematic illustration similar to FIG. 11 including more components connecting the two pairs of instances of the fourth embodiment, the connections being done in the longitudinal direction.

FIGS. 13 to 15 show schematic illustrations of the embodiment of the apparatus including various holding means shown in FIGS. 11 and 12, in three different positions of a metallic surface in relation to the waterline.

FIGS. 16 to 18 show the same schematic illustrations of FIGS. 13 to 15 respectively from a side view.

### DETAILED DESCRIPTION

A first embodiment of a holding means 3 is shown in FIG. 1. The holding means 3 includes five permanent magnets 311 which are arranged in an array. The array is parallel to the metallic surface 11. Also included in this embodiment, are four wheels 35 for allowing motion on the metallic surface 11 and to keep a fixed distance between the permanent magnets 311 and the metallic surface 11. Each wheel 35 rotates on a shaft 351 which traverses the array of permanent magnets 311.

The wheels 35 are held against the metallic surface 11 due to a pushing force being exerted by the five permanent magnets 311, towards the metallic surface 11. This pushing force results from the magnetic attraction of the permanent magnets 311 towards the metallic surface 11. In this embodiment, the pushing force is transferred from the five permanent magnets 311 to the shafts 351, which then transfer it to the wheels 35 in contact with the metallic surface 11. Hence, at the same time the four wheels 35 and the shafts 351 sustain the pushing force against the metallic surface 11, they also enable the movement on the metallic surface 11.

If the permanent magnets 311 contact directly with the metallic surface 11, then, the wheels 35 do not bear the pushing force on the metallic surface 11. This can happen, for example, due to the wheels 35 being arranged with an insufficient diameter or due to the wheels being arranged with a shaft traversing the array of permanent arrays 311 in a position that would set the wheels 35 to far away from the metallic surface 11 in relation to the permanent magnets 311.

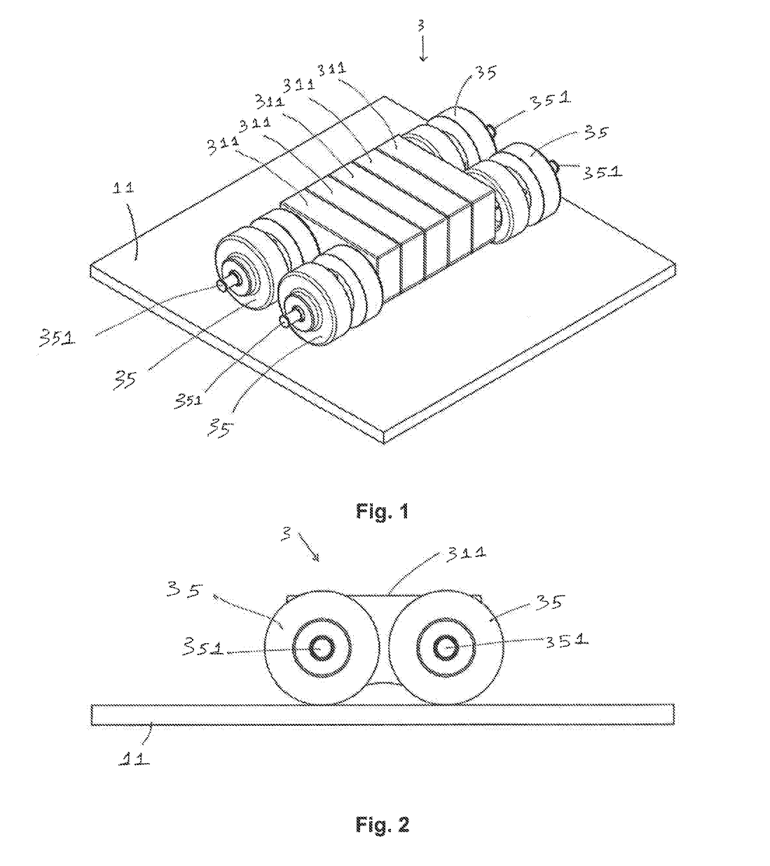

Hence, in this embodiment, the configuration of the diameter of a wheel 35 and of the position of its rotation axis in relation to the permanent magnets 311, allow arranging the wheels 35 for bearing the pushing force from the permanent magnets 311 on the metallic surface 11. This aspect can be better observed in FIG. 2, where a side view of FIG. 1 is shown.

Also, other types of magnetic means can be used, instead of a permanent magnet 311, for example an electromagnet.

FIG. 2 shows a side view of the first embodiment, shown in FIG. 1, in the longitudinal direction of the motion enabled by the wheels 35. The distance between the metallic surface 11 and the closest surface of the permanent magnets 311 can be observed between the wheels shown. Since the permanent magnets 311 do not touch the metallic surface 11, then then pushing force is correctly exerted to the shafts 351 and wheels 35.

Moreover, since the diameter of the wheels 35 and the position of the shafts 351 in relation to the permanent magnets 311 is kept fixed, then, the distance between the surface of the permanent magnets 351 which is most proximal to the metallic surface 11 and the points of contact of the wheels 35 on the metallic surface 11, will be kept constant. This constant distance will be observed while the holding means 3 moves on the metallic surface 11.

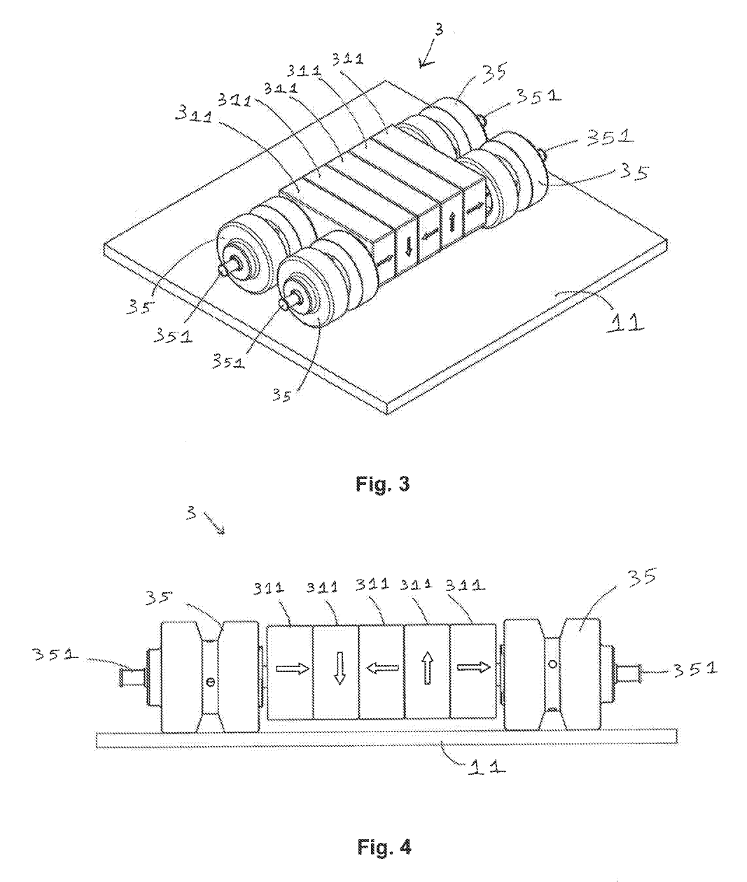

A second embodiment of the holding means 3 is shown in FIGS. 3 and 4. In this embodiment, the permanent magnets 311 shown in the first embodiment are arranged in a Halbach array, which can be observed with the illustrative arrows drawn in FIGS. 3 and 4. Each arrow represents the orientation of the magnetic field of each permanent magnet 351.

This rotating pattern of magnetisation augments the magnetic field facing the metallic surface while cancelling the magnetic field on the other side. In particular, the flux cancelled on one side reinforces the flux on the other side. Consequently, this arrangement allows achieving a stronger pushing force and, as a result, allowing, for example, to hold heavier weights against the metallic surface 11.

Other arrangements of the magnetic means could be achieved for changing the magnetic field. For example, a sub-optimal arrangement of the Halbach array can also be implemented.

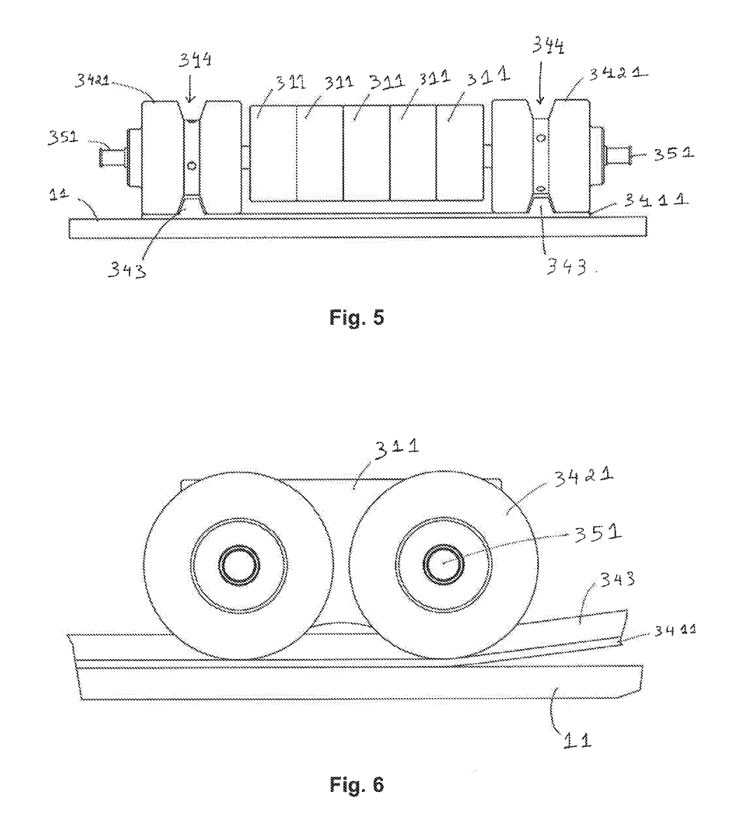

In FIGS. 5 and 6 a third embodiment of the holding means 3 is shown. This embodiment is similar to any of the previous embodiments, with the difference that it includes a continuous track system with a track belt 3411 for moving on the metallic surface 11, instead of the wheels 35 shown in any of the FIGS. 1 to 4.

The continuous track system includes rollers 3421 for conducting the track belt 3411. These rollers 3421 are similar to the wheels 35 shown in FIGS. 1 to 4, which directly contact the metallic surface 11. However, in this third embodiment, the track belt 3411 is the component that contacts directly with the metallic surface 11 and the rollers 3421 conduct is the track belt 3411.

The track belt 3411 in this third embodiment is arranged around the permanent magnets 311. This allows keeping them protected from any metallic piece that might be floating in the water or that might be detached from the metallic surface 11 due to the magnetic attraction. In this way, the track belt 3411 works as a shield for the permanent magnets 311.

The track belt 3411 shown includes two inner guides 343, which engage on an opposing groove 344 presented by the roller 3421. This engagement allows keeping the track belt 3411 aligned with the movement on the metallic surface 11. Whenever the holding means 3 turns on the metallic surface 11, which happens at the same time the permanent magnets 311 exerts a pushing force that is transferred to the track belt 3411, the inner guides 343 make the track belt 3411 also turn. Also, a different number of inner guides 343, and the corresponding grooves 344, can also be implemented.

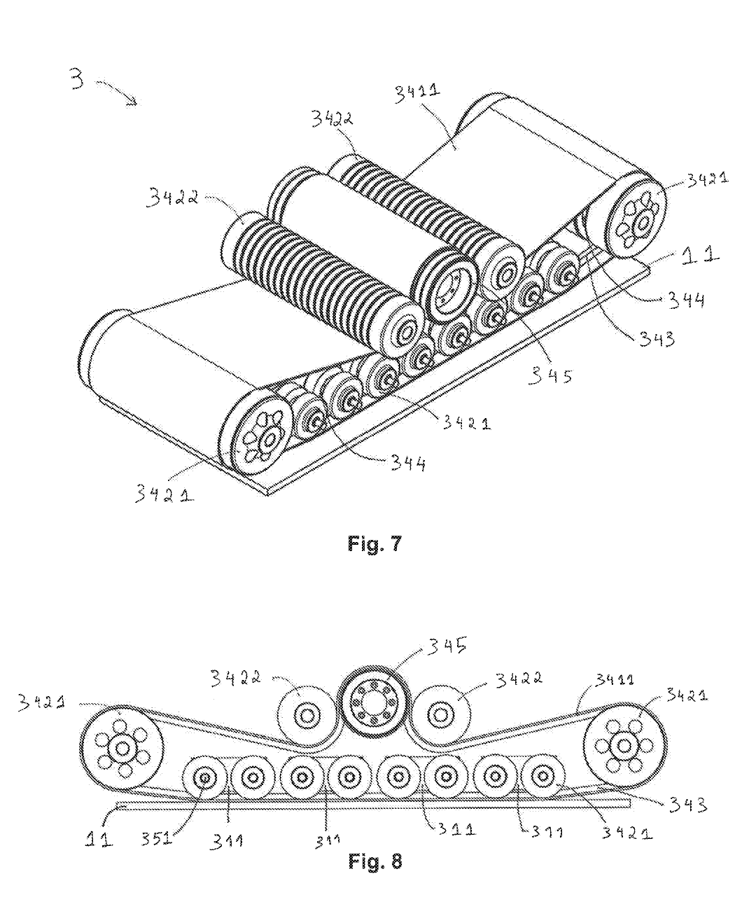

In the FIGS. 7 and 8, a fourth embodiment is illustrated including a track belt 3411 being conducted around four instances of the holding means 3 shown in any of the FIGS. 5 to 6. These instances work together, side by side, in exerting the pushing force. The track belt 3411 is conducted around the permanent magnets 311, including two inner guides 343, of which only one is visible, and several rollers 3421. Moreover, the track belt 3411 is also conducted around a driving drum 345 which allows driving the track belt 3411.

Some components have been hidden in the FIGS. 7 and 8 for allowing a better visualization of the components surrounded by the track belt 3411. However, these may also be needed in order to keep any of the rotation axes of the conducting means fixed in relation to each other, namely the rollers 3421, the outer rollers 3422, and the driving drum 345. Moreover, in order to allow fine tuning the tension of the track belt 3411, at least one rotation axis of a conducting means may be adapted to include a mechanism for regulating its position.

In this fourth embodiment, the driving drum 345 transmits torque to the track belt 3411. The driving drum 345 engages the track belt 3411 from the inside, i.e. not on the surface of the track belt 3411 that contacts the metallic surface 11. For this effect, the driving drum 345 includes a rubber coating to ensure good grip and increase the coefficient of friction. Moreover, the two outer rollers 3422 are also included to ensure a good grip for the track belt 3411 around the driving drum 345. The positions of these outer rollers 3422 change the amount of force which is transmitted to the track belt 3411. Preferably, the track belt 3411 is guided at least 180 degrees around the driving drum 345.

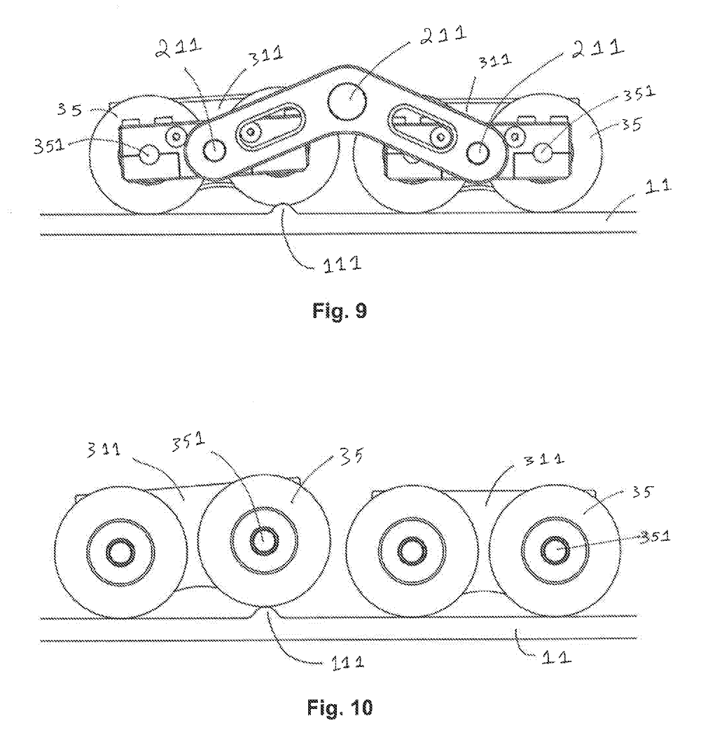

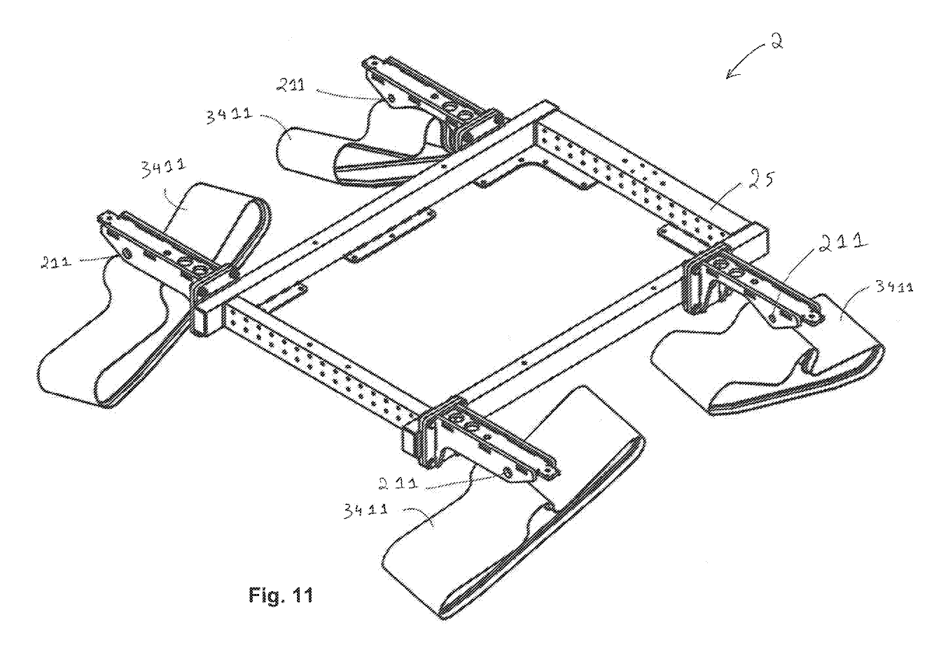

FIGS. 9 and 10 show a fifth embodiment of the holding means 3 including three pivots 211, each arranged to pivot in a transverse axis in relation to the movement on the metallic surface 11. This embodiment includes the wheels 35, but it could easily include a continuous track system instead, like the shown in any of the FIGS. 5 and 6. Also, the rotation axis of the pivots 211 is parallel to the rotation axis of the wheels 35. Moreover, the pivots 211 connect to an apparatus and allow to adapt the holding means 3 to a shape of a metallic surface 11. For example, a hull of a ship is not a flat surface, presenting a curved shape in some parts. Also, the metallic surface 11 may have a protrusion 111, such as a welded joint. In such case, when this fifth embodiment passes over it, the pivots 211 work together to adapt the permanent magnets 311 accordingly. This adaptation is show in FIG. 9 and more clearly in FIG. 10.

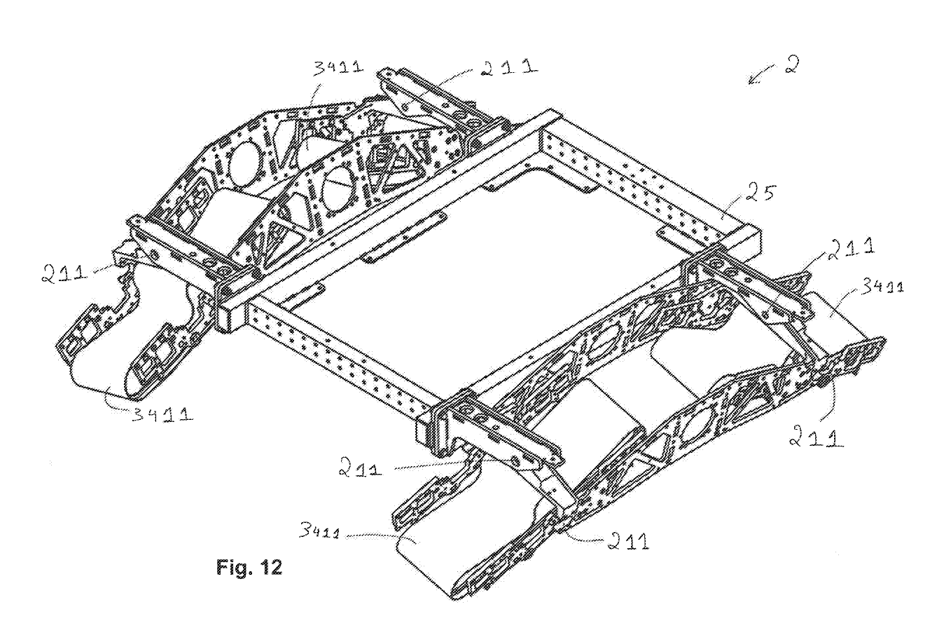

FIGS. 11 and 12 show an embodiment of an apparatus 2 including a frame 25 and four instances of the fourth embodiment shown in FIGS. 7 and 8. Also included in this embodiment of the apparatus 2 are the pivots 211 for adapting the holding means 3 to different shapes of the metallic surface 11. Some of the pivots 211 pivot each instance of the fourth embodiment in a transverse axis, and others pivot each longitudinal pair of instances in a longitudinal axis.

The frame of the apparatus 2 may be used to carry any tools or devices needed for performing an operation on the metallic surface 11.

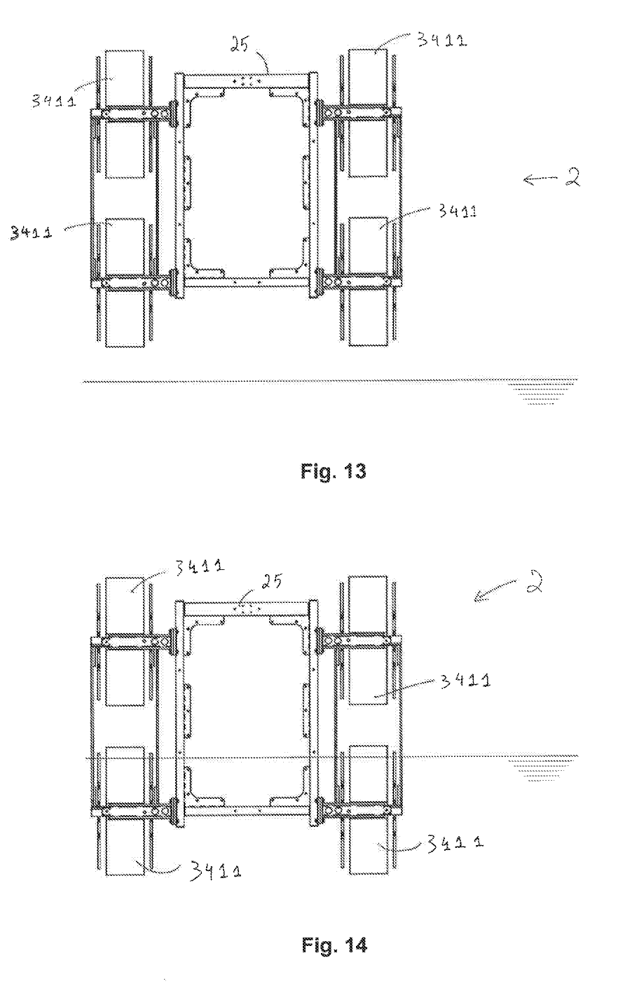

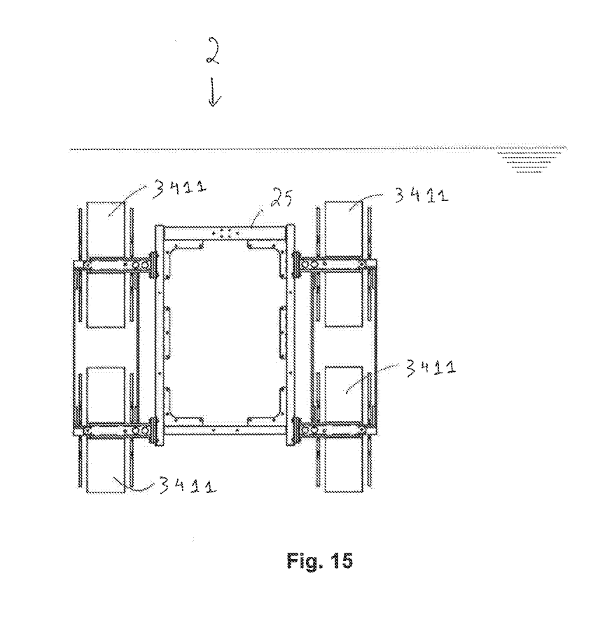

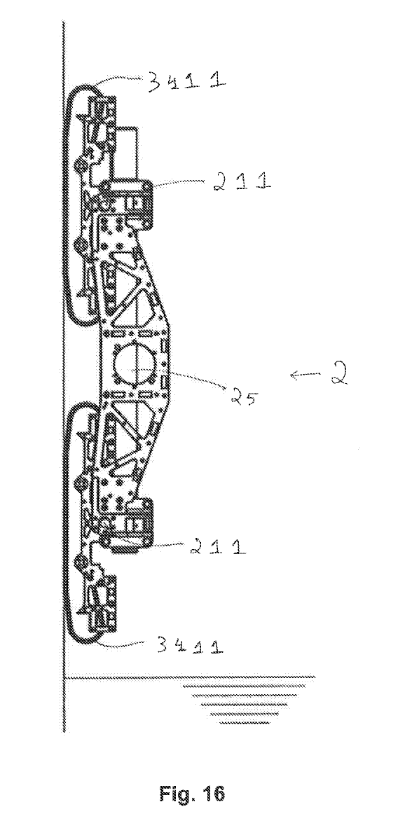

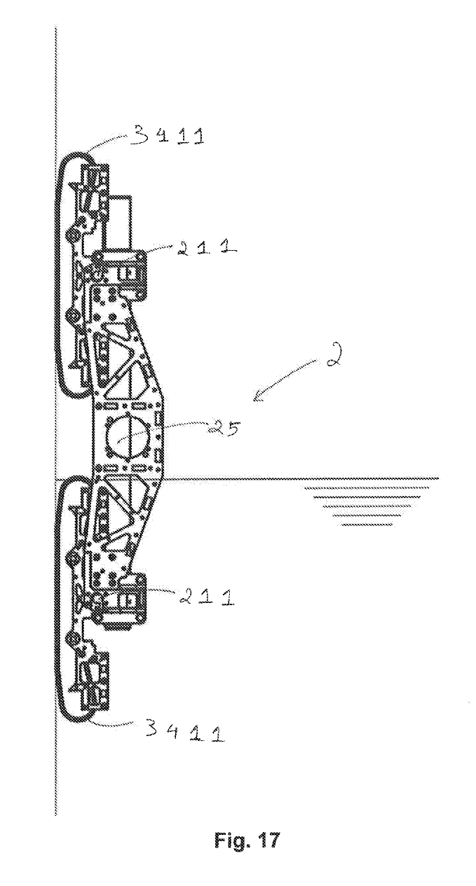

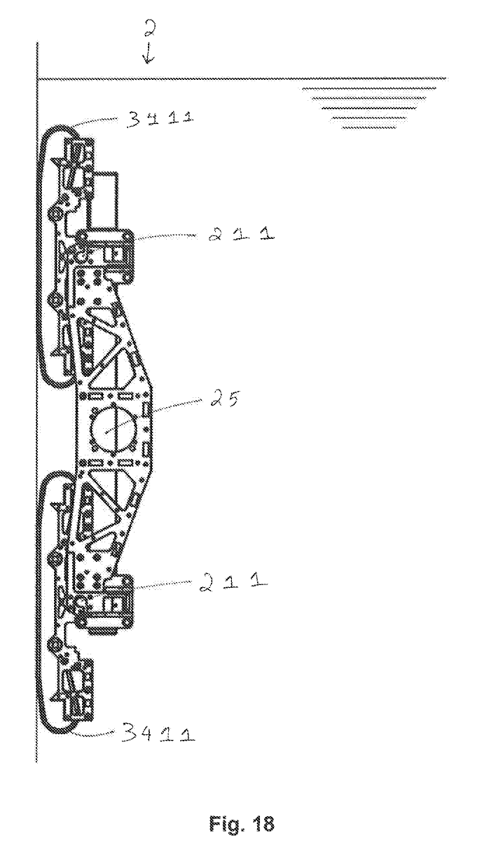

FIGS. 13 to 15 the embodiment of the apparatus 2 from FIGS. 11 and 12, in three different positions of a metallic surface 11, for example a hull of an offshore unit, in relation to the waterline. FIGS. 16 to 18 show the same scenario of FIGS. 13 to 15, respectively from a side view. An embodiment of an apparatus 2 including at least one instance of a holding means 3 can be used for performing an operation on a metallic surface which is partly submerged. For example, FIGS. 14 and 17 illustrate the position of the apparatus 2 in the, so called, splash zone of the metallic surface 11. In this case, also the apparatus 2 is partly submerged, working under the complex hydrodynamic conditions observed thereon.

Any of the above embodiments can be used to perform an operation in a metallic hull. The metallic hull may be part of a vessel, such as a ship, or part of an offshore unit. An offshore unit is considered to be any structure engaged in offshore operations including drilling, oil and gas production and storage, accommodation and other support functions.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1-13. (canceled)

14. An apparatus for performing an operation on a metallic surface, wherein the metallic surface is an outer surface of a metallic hull and the metallic hull is part of a ship or of an offshore unit, the apparatus comprising:
at least one holding means for holding the apparatus against the metallic surface while the apparatus is partially immersed; and
at least one pivoting means for pivoting the at least one holding means in relation to the apparatus,
wherein the holding means comprises:
at least one magnetic means for exerting a pushing force on the apparatus towards the metallic surface; and
a moving means for moving the apparatus on the metallic surface,
wherein the moving means is arranged to bear the pushing force from the at least one magnetic means on the metallic surface,
wherein the at least one pivoting means is arranged for adapting the at least one holding means to a shape of the metallic surface, and
wherein the at least one pivoting means is arranged to pivot in a transverse axis in relation to the movement of the apparatus on the metallic surface, and
wherein the at least one magnetic means is arranged in a Halbach array for augmenting a magnetic field of the magnetic means facing the metallic surface.

15. The apparatus according to claim 14, wherein the at least one pivoting means is arranged to pivot in a longitudinal axis in relation to the movement of the apparatus on the metallic surface.

16. The apparatus according to claim 14, wherein the moving means comprises a continuous track system for moving the apparatus on the metallic surface, the continuous track system comprising:
a continuous track; and
at least two conducting means for conducting the continuous track.

17. The apparatus according to claim 16, wherein the continuous track of the continuous track system is arranged around the at least one magnetic means, for keeping the at least one magnetic means separated from the metallic surface.

18. The apparatus according to claim 16, wherein the continuous track is adapted with at least one inner guide for keeping the continuous track aligned with the movement of the apparatus on the metallic surface, and
wherein at least two conducting means is adapted with a groove for the at least one inner guide to engage thereon.

19. The apparatus according to claim 16, wherein the continuous track is a track belt.

20. The apparatus according to claim 15, wherein the moving means comprises a continuous track system for moving the apparatus on the metallic surface, the continuous track system comprising:
a continuous track; and
at least two conducting means for conducting the continuous track.

21. The apparatus according to claim 17, wherein the continuous track is adapted with at least one inner guide for keeping the continuous track aligned with the movement of the apparatus on the metallic surface, and
wherein at least two conducting means is adapted with a groove for the at least one inner guide to engage thereon.

22. The apparatus according to claim 17, wherein the continuous track is a track belt.

23. The apparatus according to claim 18, wherein the continuous track is a track belt.
